(19) United States
(12) Patent Application Publication
(10) Pub. No.: US 2026/0212444 A1
(43) Pub. Date: Jul. 23, 2026

(54) GENERATING ANGULAR SNAPPING GUIDES FOR MANIPULATING VECTOR-BASED DESIGNS

(71) Applicant: Adobe Inc., San Jose, CA (US)

(72) Inventors: Arushi Jain, Delhi (IN); Praveen Kumar Dhanuka, Howrah (IN)

(21) Appl. No.: 19/028,973

(22) Filed: Jan. 17, 2025

(51) Int. Cl. G06T 3/153; G06T 3/20

(52) U.S. Cl. CPC G06T 3/153; G06T 3/20; G06T 2200/24

(57) ABSTRACT

The present disclosure relates to systems, non-transitory computer-readable media, and methods for generating and utilizing equidistant angular guides to align a modified object relative to multiple other objects in a digital image. For example, the disclose systems identify a set of snappable segments within a graphical user interface of a digital illustration application. In some embodiments, the disclosed systems detect a user interaction for modifying a first object. The disclosed systems determine a modified alignment position for the first object that positions the first object along a non-vertical and non-horizontal angular alignment guide such that the first segment, second segment, and third segment are separated by equal distances along the angular alignment guide. In various embodiments, the disclosed systems additionally provide a snappable graphical user interface element in the graphical user interface that, upon selection, causes the first object to move into the modified alignment position.

### BACKGROUND

Recent years have seen significant advancements in hardware and software platforms for creating and editing digital illustration documents. For example, many platforms provide software applications that contain tools to modify objects within digital illustration documents. To illustrate, in the field of digital image editing, many platforms provide computer-implemented tools or algorithms to help guide the modification of objects. Despite the advancements of conventional digital illustration systems that utilize these tools, however, these conventional systems continue to suffer from a number of disadvantages in relation to efficiency, accuracy, and operational flexibility.

### BRIEF SUMMARY

One or more embodiments described herein provide benefits and/or solve one or more of the foregoing or other problems in the art with systems, methods, and non-transitory computer-readable media that generate and utilize equidistant angular guides to facilitate the angular alignment of a modified object relative to multiple objects in a digital illustration document. To illustrate, in one or more embodiments, the disclosed systems generate and provide equidistant angular guides and/or snapping segments between multiple objects relative to a modified object within a digital illustration document. Further, in some embodiments the disclosed systems also address the issue of real-time guidance regarding the equidistant angular positioning of an object, rather than in the vertical or horizontal direction, and utilize an efficient data structure to analyze the snappable segments of all objects in the environment view. Using this structure, the disclosed systems determine an aligned position for a modified object relative to the angular position of other objects within the artwork. In this manner, the disclosed systems provide precise, intuitive, and visible equidistant angular alignment of a modified object with respect to other object segments in the artwork.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a diagram of an environment in which an equidistant angular alignment system can operate in accordance with one or more embodiments.

FIG. 2 illustrates an overview diagram of the equidistant angular alignment system aligning a modified object relative to multiple objects in accordance with one or more embodiments.

FIG. 3 illustrates a diagram of the equidistant angular alignment system extracting snappable segments from objects portrayed in a digital illustration document in accordance with one or more embodiments.

FIGS. 4A-4B illustrate a diagram of the equidistant angular alignment system generating an alignment bin map for snappable segments from objects portrayed in a digital illustration document in accordance with one or more embodiments.

FIGS. 5A-5B illustrate a diagram of the equidistant angular alignment system generating probable alignment triplets in accordance with one or more embodiments.

FIG. 6A illustrates a diagram of the equidistant angular alignment system performing operations for generating and displaying alignment suggestions for equidistant angular alignment of objects in accordance with one or more embodiments.

FIG. 6B illustrates a diagram of the equidistant angular alignment system selecting a triplet for equidistant angular alignment of objects in accordance with one or more embodiments.

FIG. 7 illustrates an example of the equidistant angular alignment system generating suggested equidistant angular alignments in accordance with one or more embodiments

FIG. 8 illustrates a schematic diagram of the equidistant angular alignment system in accordance with one or more embodiments.

FIG. 9 illustrates a flowchart of a series of acts for facilitating the equidistant angular alignment of a modified object relative to multiple other objects in accordance with one or more embodiments

FIG. 10 illustrates a block diagram of an example computing device for implementing one or more embodiments of the present disclosure.

### DETAILED DESCRIPTION

One or more embodiments described herein include an equidistant angular alignment system that generates and utilizes equidistant angular guides to align a modified object relative to multiple other objects in a digital illustration document (e.g., a digital image). For example, in some embodiments, the equidistant angular alignment system suggests a modified alignment position for a snappable segment of a modified object relative to snappable segments of multiple other objects while ensuring that the distance between the objects is equal with respect to angular alignment. Moreover, in some embodiments, the equidistant angular alignment system utilizes the modified alignment position to generate a snappable graphical user interface element visible in the viewport (e.g., graphical user interface), enabling alignment of the modified object at equal distances from multiple objects along an angular path (e.g., a non-horizontal, non-vertical path).

As described above, the equidistant angular alignment system determines snappable segments of a modified object for providing angular alignment. Specifically, in one or more embodiments, the equidistant angular alignment system utilizes an object-based alignment to facilitate the angular alignment of an object relative to multiple other objects within a digital illustration document. To illustrate, in one or more embodiments, the equidistant angular alignment system extracts snappable segments from objects in a digital illustration document and stores the snappable segments in angular alignment bins relative to the angle of the snappable segments.

In response to a modification (e.g., rotation/translation/scaling) of an object within an illustration document, the equidistant angular alignment system utilizes the angular alignment bins to determine a modified alignment position for the modified object, angularly aligning the object with a second object and a third object such that the three objects are separated by equal distances along an angular path. In some cases, the equidistant angular alignment system recommends and/or snaps the modified object to that position. Accordingly, the equidistant angular alignment system positions the modified object based on the relative positions of the second object and the third object within the viewport of the digital illustration document.

As mentioned above, many conventional systems suffer from a number of issues in relation to computational inefficiency, inaccuracy, and operational flexibility. For example, some existing digital illustration systems inefficiently require designers looking to angularly align multiple objects at equal distances to perform excessive interactions and attempt multiple iterations of manual alignment. For instance, existing digital illustration systems that provide conventional tools for object modification result in slow object positioning, requiring tedious manipulation of existing tools (e.g., by drawing additional paths) to confirm equal distances and correct angular alignment.

Furthermore, in some instances, existing digital illustration systems suffer from resource-intensive grid searching, which consumes significant computing resources, such as memory and processing power. For example, some existing systems provide horizontal and/or vertical alignment between objects using object bounding boxes to determine alignment. Often, existing tools that iterate over the bounding boxes of objects in a digital illustration document increases complexity in the overall process of generating alignment guides. Such computational resource utilization results in slow object positioning, leading to delays in intended modifications of objects within a digital illustration. This is particularly true when an object count in a digital illustration document is high.

Relatedly, existing digital illustration systems suffer from computational inaccuracy. As previously mentioned, current systems that allow for free movement of objects are also often inaccurate, prone to user error and imprecise alignment. As such, a designer of existing digital illustration systems often fails to correctly align an object on an axis relative to other objects within a digital illustration document. Specifically, in some instances, the lack of equidistant angular alignment guides limits a designer's ability to evenly space multiple objects around a central point and/or axis, resulting in visual imbalance and misalignments across multiple objects with current digital illustration systems.

In addition to problems of inefficiency and inaccuracy, conventional digital illustration systems also experience problems of operational inflexibility. For example, as mentioned, conventional systems often restrict object positioning to alignment with predictive grid lines in the horizontal and vertical space. Additionally, a forced snapping operation restricted to horizontal/vertical alignment limits accurate position control over the location of an object. Thus, many of the inefficiency and inaccuracy issues discussed above also result in the inflexibility of current digital illustration systems.

As suggested, one or more embodiments of the equidistant angular alignment system provide several advantages over conventional digital illustration systems. For example, in one or more embodiments, the equidistant angular alignment system improves computational efficiency over current digital illustration systems. In contrast to conventional digital illustration systems that require excessive user interactions to position objects at equal distances along a particular path, the equidistant angular alignment system provides guides and snapping for equidistant positioning along any angular path, including non-horizontal/non-vertical or horizontal/vertical paths. Specifically, the equidistant angular alignment system utilizes angular alignment guides to generate a modified alignment of an object for along an angular path relative to multiple other objects at equal distances (e.g., by utilizing individually detected paths of the objects and alignment bins). As such, the equidistant angular alignment system provides improved efficiency over existing tools by providing equidistant angular placement of an object relative to other objects with minimal user interactions via a user interface.

Furthermore, the equidistant angular alignment system improves efficiency over conventional systems. As mentioned, conventional digital illustration systems suffer from computational inefficiency due to the significant computational resources required to evaluate snappable objects along only horizontal or vertical paths. In contrast, the equidistant angular alignment system reduces computation time (computational complexity) in generating a modified alignment by generating a bin alignment structure based on a snapping tolerance for horizontal, vertical, or non-horizontal/non-vertical alignment. Furthermore, in some embodiments, the organization of segments of objects within bin alignment structures according to signed distance also facilitates efficiency. Thus, the equidistant angular alignment system, in various embodiments, efficiently provides real time recommendations for a modified object to align the modified object at equal distances relative to other objects along angular paths.

Relatedly, the equidistant angular alignment system improves accuracy over conventional digital illustration systems. As discussed previously, in some embodiments, the equidistant angular alignment system provides real time recommendations to angularly align a modified object at equal distances to other objects. In doing so, the equidistant angular alignment system accurately suggests modified alignments of an object along an angular alignment guide that extends along a non-vertical and non-horizontal angle, equally spacing the object relative to multiple other objects. Thus, in contrast to conventional systems that rely on manual alignment, the equidistant angular alignment system provides angular alignment guides and snapping that results in precise alignment in real time.

Similarly, the equidistant angular alignment system improves upon operational flexibility by providing angular alignment of objects in digital illustration documents. For example, in contrast to conventional systems that rigidly prioritize object alignment based on a bounding box (vertical/horizontal alignment) of an object, the equidistant angular alignment system aligns objects based on snappable segments associated with an object's individual paths or Bezier curves (linear lines, almost linear lines, curved lines). In doing so, the equidistant angular alignment system allows for the equidistant angular alignment of multiple objects relative to each other, allowing for more efficient, complicated designs while also providing accurate equidistant spacing along various angular paths.

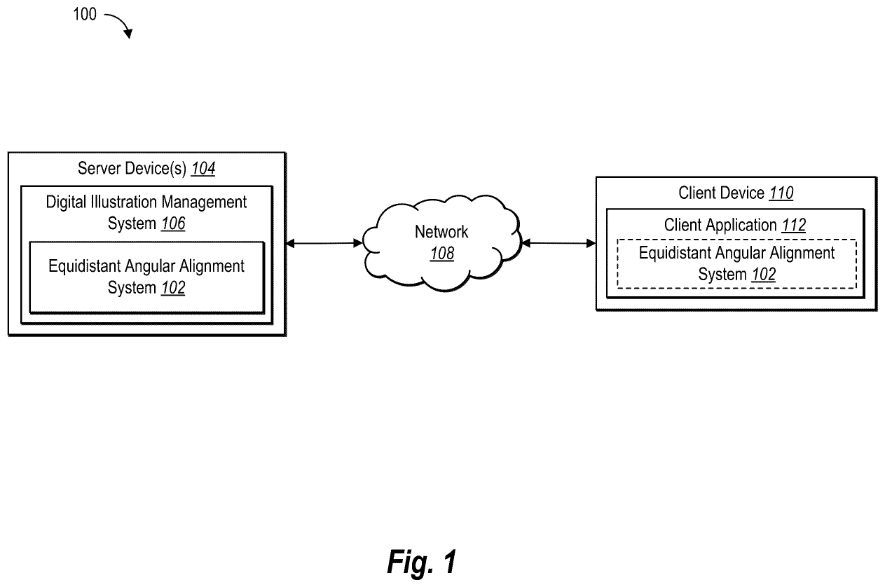

Additional details regarding the snapping guide decluttering system will now be provided with reference to the figures. For example, FIG. 1 illustrates a schematic diagram of an exemplary system environment 100 in which an equidistant angular alignment system 102 operates. As illustrated in FIG. 1, the system environment 100 includes server device(s) 104, a digital illustration management system 106, an equidistant angular alignment system 102, a network 108, a client device 110, and a client application 112.

Although the system environment 100 of FIG. 1 is depicted as having a particular number of components, the system environment 100 is capable of having a different number of additional or alternative components (e.g., a different number of servers, client devices, or other components in communication with the equidistant angular alignment system 102 via the network 108). Similarly, although FIG. 1 illustrates a particular arrangement of the server device(s) 104, the network 108, and the client device 110, various additional arrangements are possible.

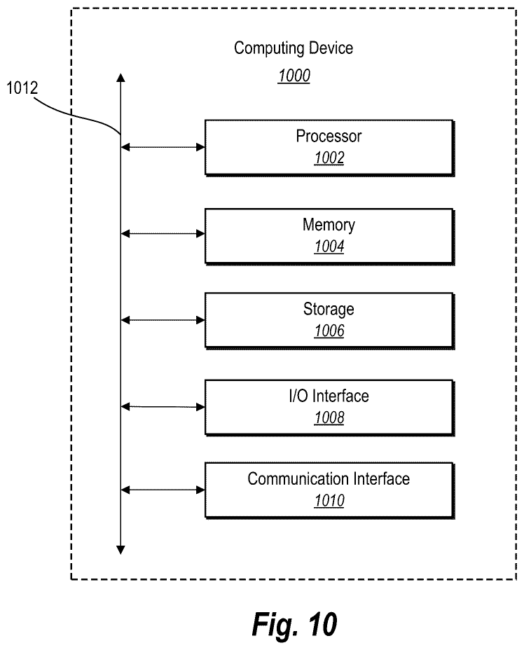

The server device(s) 104, the network 108, and the client device 110 are communicatively coupled with each other either directly or indirectly (e.g., through the network 108 discussed in greater detail below in relation to FIG. 10). Moreover, the server device(s) 104 and the client device 110 include one or more of a variety of computing devices (including one or more computing devices as discussed in greater detail in relation to FIG. 10).

As mentioned above, the system environment 100 includes the server device(s) 104. In one or more embodiments, the server device(s) 104 processes input to modify one or more objects within a client application (e.g., a digital illustration application for generating or editing digital illustration documents) from a user of the client application 112 to snapping guides associated with the modification. In one or more embodiments, the server device(s) 104 comprises a data server. In some implementations, the server device(s) 104 comprises a communication server or a web-hosting server.

In one or more embodiments, the client device 110 includes a computing device that is able to provide, for display via the client application 112, entities within a digital illustration document (e.g., a digital image such as a vector-based image or a raster-based image or a PDF file) such as objects, tools, user interface panels, and snapping guides on a graphical user interface of the client application 112. For example, the client device 110 includes smartphones, tablets, desktop computers, laptop computers, head-mounted-display devices, or other electronic devices. The client device 110 includes one or more applications (e.g., the client application 112) for modifying objects (e.g., generating or editing digital illustration documents) in accordance with the digital illustration management system 106. For example, in one or more embodiments, the client application 112 works in tandem with the equidistant angular alignment system 102 to determine a suggested equidistant angular modified alignment of a modified object to provide via the client application 112. In particular, the client application 112 includes a software application installed on the client device 110. Additionally, or alternatively, the client application 112 of the client device 110 includes a software application hosted on the server device(s) 104 which may be accessed by the client device 110 through another application, such as a web browser.

To provide an example implementation, in some embodiments, the equidistant angular alignment system 102 on the server device(s) 104 supports the equidistant angular alignment system 102 on the client device 110. For instance, in some cases, the digital illustration management system 106 on the server device(s) 104 gathers data for the equidistant angular alignment system 102. In response, the equidistant angular alignment system 102, via the server device(s) 104, provides the information to the client device 110. In other words, the client device 110 obtains (e.g., downloads) the equidistant angular alignment system 102 from the server device(s) 104. Once downloaded, the equidistant angular alignment system 102 on the client device 110 provides a suggested equidistant angular modified alignment of a modified object (e.g., via one or more alignment guides and/or alignment snapping operations).

In alternative implementations, the equidistant angular alignment system 102 includes a web hosting application that allows the client device 110 to interact with content and services hosted on the server device(s) 104. To illustrate, in one or more implementations, the client device 110 accesses a software application supported by the server device(s) 104. In response, the equidistant angular alignment system 102 on the server device(s) 104 provides a modified alignment position of a modified object to the client device 110 for display.

To illustrate, in some cases, the equidistant angular alignment system 102 on the client device 110 receives an object modification input. The client device 110 transmits the object modification input to the server device(s) 104. In response, the equidistant angular alignment system 102 on the server device(s) 104 generates a modified alignment position of a modified object to cause the client device 110 to display via the graphical user interface of the client application 112.

Indeed, in some embodiments, the equidistant angular alignment system 102 is implemented in whole, or in part, by the individual elements of the system environment 100. For instance, although FIG. 1 illustrates the equidistant angular alignment system 102 implemented or hosted on the server device(s) 104, different components of the equidistant angular alignment system 102 are able to be implemented by a variety of devices within the system environment 100. For example, one or more (or all) components of the equidistant angular alignment system 102 are implemented by a different computing device (e.g., the client device 110) or a separate server from the server device(s) 104. Indeed, as shown in FIG. 1, the client device 110 includes the equidistant angular alignment system 102. Example components of the equidistant angular alignment system 102 will be described below with regard to FIG. 10.

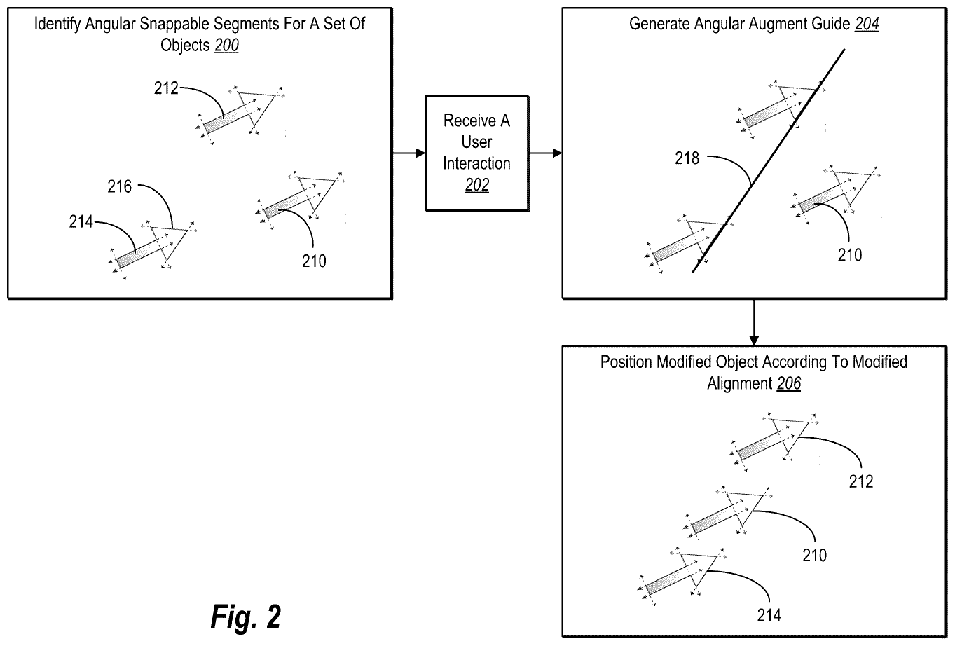

As mentioned above, in certain embodiments, the equidistant angular alignment system 102 performs operations for providing equidistant positioning of an object relative to multiple other objects along a non-horizontal and non-vertical path. FIG. 2 illustrates an overview diagram of the equidistant angular alignment system 102 aligning a modified object relative to multiple other objects along an angular path in accordance with one or more embodiments.

Indeed, as shown in FIG. 2, the equidistant angular alignment system 102 identifies angular snappable segments 216 for a set of objects. In particular, the act 200 of identifying angular snappable segments includes identifying individual portions (e.g., paths, edges, or tangents) of objects within a viewport of a digital illustration application. In one or more embodiments, a digital illustration application includes an application for creating and editing illustrations and artwork. In some instances, the digital illustration application includes tools such as brushes, drawing tools, and painting tools. Furthermore, in some instances digital illustration applications also provide tools for inserting or editing text input fields. Accordingly, the digital illustration application, in some cases, includes tools for modifying elements within a digital illustration document associated with the digital illustration application. For example, a digital illustration document includes a digital image such as a vector-based image.

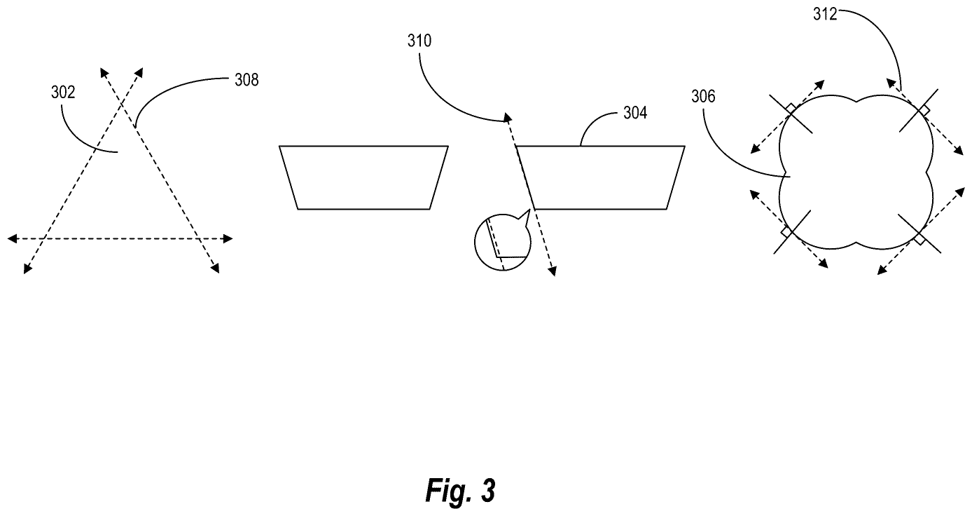

As mentioned above, the equidistant angular alignment system 102 performs an act 200 of identifying angular snappable segments for a set of objects. For example, an object includes a collection of pixels that depicts a user-interface element, shape, person, place, text, or thing. Furthermore, the equidistant angular alignment system 102 determines each object by the borders of the object, which include specific associated segments (e.g., linear lines, almost linear lines, and/or curved lines). For instance, an arrow-shaped object of FIG. 2 has six Bezier segments associated with the object. The act 200 of identifying angular snappable segments for a set of objects is discussed further in reference to FIG. 3 below.

As shown in FIG. 2, the equidistant angular alignment system 102 further performs an act 202 of receiving a user interaction. In some embodiments, the user interaction includes a user interaction via a client device to modify an object in a digital illustration document. This modification may be a scaling action, a rotation action, a translation action, or some other modification or combination thereof that changes a positioning, shape, or scale of one or more individual segments of the object. In particular, the equidistant angular alignment system 102 receives the user interaction from a user of a client device via the digital illustration application. Further, when an object is modified, the equidistant angular alignment system 102 adjusts locations of the snappable segments within the viewport accordingly.

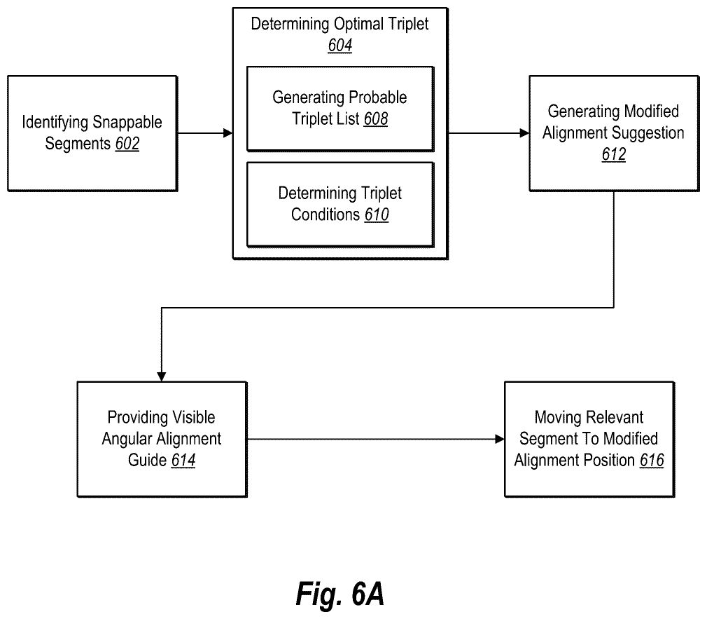

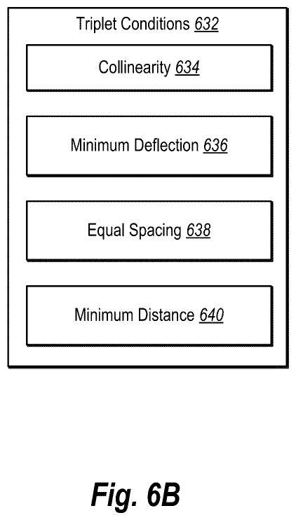

Moreover, as shown in FIG. 2, the equidistant angular alignment system performs an act 204 of generating an angular alignment guide 218 for a modified object 210 based on receiving a user interaction. Specifically, in some cases, the act 204 of generating an angular alignment guide 218 includes providing an angular alignment guide 218 (e.g., a visible graphical user interface element) to equidistantly align the modified object 210 relative to multiple other objects (e.g., objects 212, 214) along a linear (or approximately linear within a threshold) path within the viewport. The act 204 of generating an angular alignment guide 218 is further discussed below in the description of FIGS. 6A-6B.

Moreover, an angular alignment guide 218 includes a visual or functional element within a digital illustration application to help align and position objects accurately and precisely with equal distances between the objects along a single path. For instance, the equidistant angular alignment system 102 provides an angular alignment guide 218 (e.g., a snappable guide) for a user to maintain consistency, accuracy, and visual order in the digital illustration document. Additionally, in some instances, the equidistant angular alignment system 102 utilizes angular alignment guides to allow for an object to automatically attract or snap to positions in alignment with other objects within the digital illustration document.

Further, as shown in FIG. 2, based on the act 204 of generating the angular alignment guide 218 the equidistant angular alignment system performs an act 206 of positioning the modified object 210 according to a modified alignment along the angular alignment guide 218. In some embodiments, the equidistant angular alignment system positions the modified object 210 such that the modified object 210 is equidistantly aligned with multiple other objects (e.g., objects 212, 214) within the viewport. In some cases, the equidistant angular alignment system 102 places the modified object equidistantly between multiple other objects. Alternatively, in other cases, the equidistant angular alignment system 102 places the modified object to the side (left/right in relation to an x-axis) of multiple other objects, with the objects each positioned an equal distance apart along an angular path. For example, equidistant alignment refers to the arrangement of multiple objects such that the distances between the objects along a path are equal. Specifically, equidistant angular alignment, in some cases, refers to the arrangement of objects along an angular or radial line (visible or not visible) defining a path where each object is spaced at equal distances from its neighboring objects along the path.

As mentioned, in one or more embodiments, the equidistant angular alignment system 102 identifies snappable segments (e.g., angular snappable segments) for a set of objects visible in a viewport. In particular, the equidistant angular alignment system 102 identifies Bezier segments and/or line segments of one or more objects in the viewport of a digital illustration document. FIG. 3 illustrates an equidistant angular alignment system extracting snappable segments from objects portrayed in a digital illustration document in accordance with one or more embodiments.

As shown in FIG. 3, to identify angular snappable segments of a set of objects, the equidistant angular alignment system 102 extracts angular snappable segments from objects within a viewport of a digital illustration document. In some embodiments, the equidistant angular alignment system 102 extracts angular snappable segments based on Bezier segments associated with each object. For example, a Bezier segment is a portion of a Bézier curve, defined by a specific set of control points, that represent a smooth, parametric curve. For instance, a first object 302 (a triangle) includes three angular snappable segments 308 based on the three linear segments that form the border of the shape. Additionally, for a second object 304 (a trapezium), the border of the shape is comprised of almost linear line segments (e.g., within a threshold tolerance). Because almost linear segments are most closely approximated by linear segmentation, the equidistant angular alignment system 102 determines that the corresponding angular snappable segments are linear Bezier segments (e.g., linear snappable segment 310). That is, in some cases where curved segments are approximated by linear segments within a predetermined threshold, the equidistant angular alignment system 102 determines that the extracted snappable segments are linear.

Moreover, by way of example, a third object 306 (a clover shape), which has a border that includes curved line segments, the equidistant angular alignment system 102 determines angular snappable segments based on tangents at the extreme (e.g., outer edge) of the curved line segment. For example, for the clover shape of the third object 306, the equidistant angular alignment system 102 extracts four tangential snappable segments 312 based on four corresponding curved line segments. Thus, in some embodiments, the equidistant angular alignment system 102 extracts snappable segments for non-vertical, non-horizontal alignments as well as for vertical and horizontal alignments as determined by individual segments of objects. The equidistant angular alignment system 102 extracts the angular snappable segments and stores the segments to be utilized as further described below.

In some cases, the equidistant angular alignment system 102 extracts the snappable segments from a plurality of objects in the viewport. In various embodiments, the equidistant angular alignment system 102 extracts the snappable segments from the modified object, with the equidistant angular alignment system 102 denoting the snappable segments of the modified object as relevant segments. In one or more embodiments, a relevant segment includes a snappable segment of the modified object that will be moved as to be in equidistant angular alignment with multiple other objects (e.g., with segments of other objects) in the viewport.

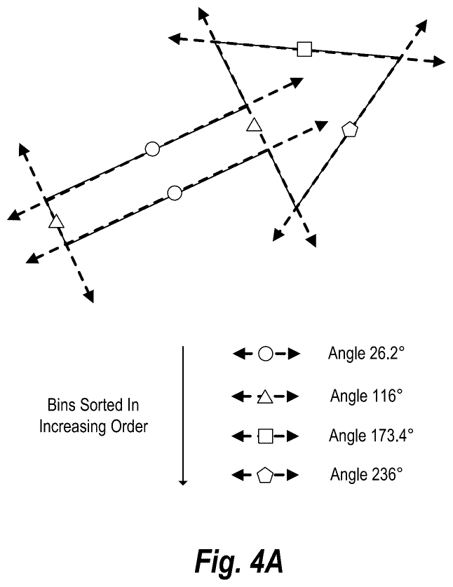

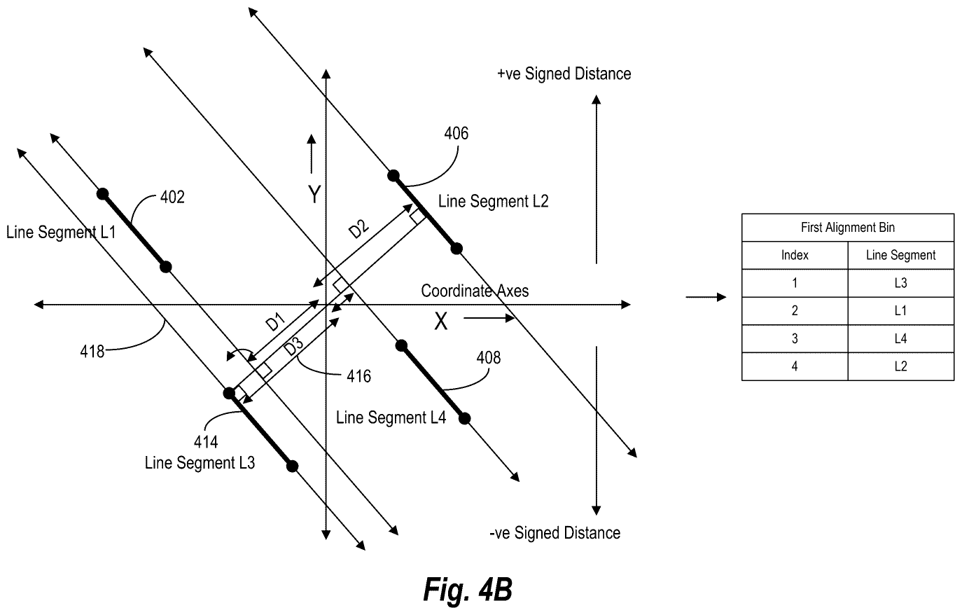

As mentioned above, the equidistant angular alignment system 102 extracts angular snappable segments from objects within a viewport to utilize in determining a position for snapping a relevant segment of a modified object to provide equidistant alignment along a path. FIGS. 4A-4B illustrate an equidistant angular alignment system generating an alignment bin map for snappable segments from objects portrayed in a digital illustration document in accordance with one or more embodiments. For example, FIG. 4A illustrates the equidistant angular alignment system 102 generating angular bins based on the angle of the extracted angular snappable segments relative to a horizontal reference line (e.g., an x-axis) and/or based on a signed distance relative to an origin point.

As further shown in FIG. 4A, the equidistant angular alignment system 102 sorts the angular snappable segments extracted from each object according to the angle of each snappable segment relative to a horizontal reference line. Furthermore, in some embodiments, the equidistant angular alignment system 102 creates a certain number of angular bins utilizing a predetermined angle tolerance. For instance, if the predetermined tolerance is five degrees, the equidistant angular alignment system 102 creates 72 (e.g., 360 degrees divided by five degrees) angular bins. In various embodiments, the equidistant angular alignment system 102 creates a larger or smaller number of angular bins than 72 depending on the predetermined angular tolerance.

As illustrated, to facilitate computational efficiency, in some cases, the equidistant angular alignment system 102 sorts the angular bins in increasing order relative to the reference line (e.g., x-axis). In some embodiments, the equidistant angular alignment system 102 performs angular bin map generation for snappable segments (e.g., snappable locations) by executing an algorithm represented by the following pseudo code:

Algorithm 1: Creation of Angular Bin

```
Require: tolerance for snapping th, list of snappable locations Σ
procedure KEY(val)
    $key ← \frac{val}{th}$
    return integer part of key
procedure INSERTION (l, B)
    m ← slope of l
    0 ← KEY(m)
    Add l in B[θ]
B is Angular Bin Map with value being list of location whose slope lies in
that bin for each lᵢ in Σ do
    INSERTION (lᵢ, B)
for each angle θ in B do
    σ ← B[θ]
```

Sort σ based on the signed distance of location. For the same signed distance of location, ordering is done based on the projection of starting point of location on y axis.

As shown in FIG. 4B, to further facilitate computational efficiency, in some embodiments, the equidistant angular alignment system 102 further sorts the snappable segments within each angular bin. As illustrated, the equidistant angular alignment system 102 arranges the snappable segments within their respective bin according to their signed distance from a reference point or origin within the digital illustration document. For example, a signed distance refers to the perpendicular distance from the origin to a snappable segment or the extended ray of a snappable segment with a sign indicating a positive or negative position with respect to the origin (e.g., on a specific side of the x-axis). In some cases, the equidistant angular alignment system 102 extends snappable segments so that they extend indefinitely in the direction of the slope of the snappable segment (relative to a horizontal reference line or x-axis), as illustrated by the rays shown in FIG. 4B such as ray 418, associated with snappable segment 414.

As illustrated in FIG. 4B, in some embodiments, the equidistant angular alignment system 102 assigns signed distances located below the x-axis a negative signed distance value (e.g., signed distance 416). Additionally, the equidistant angular alignment system assigns signed distances above the x-axis (horizontal reference line) corresponding positive values. From these determinations, in some cases, the equidistant angular alignment system 102 sorts the snappable segments within their associated angular bins from greatest signed distance to least signed distance (or from smallest signed distance to largest signed distance). For example, as illustrated in FIG. 4B, the line segments are sorted from largest signed distance to smallest signed distance (e.g., snappable segment 406, followed by snappable segment 408, followed by snappable segment 402, followed by snappable segment 414).

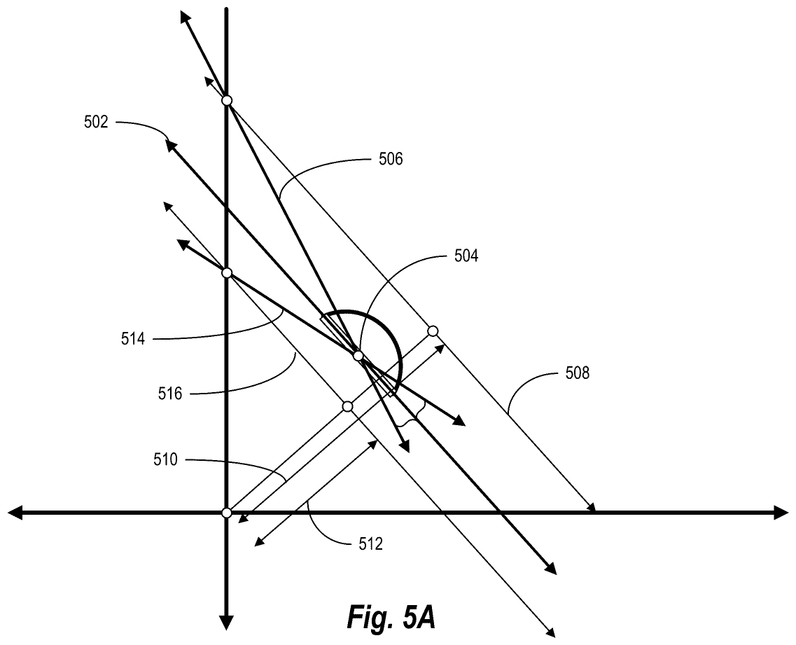

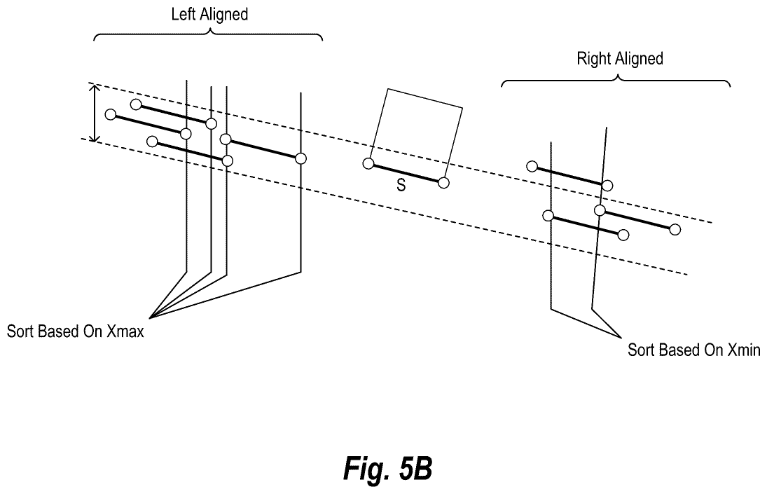

As mentioned above, in certain embodiments, the equidistant angular alignment system 102 accesses the angular bins in determining the modified alignment of the modified object. In particular, the equidistant angular alignment system 102 determines a list of probable triplets comprising three snappable segments of separate objects (including the modified object) to determine possible modified alignment positions of the modified object. FIGS. 5A-5B illustrate an equidistant angular alignment system generating probable alignment triplets in accordance with one or more embodiments.

FIG. 5A illustrates the equidistant angular alignment system 102 determining which extracted snappable segments fall within a signed distance threshold relative to a snappable segment of a modified object (relevant segment). In some embodiments, the equidistant angular alignment system 102 only evaluates snappable segments that fall within the signed distance range (tolerance zone) for determining probable alignment triplets. For example, a probable alignment triplet refers to a set of three snappable segments, including a relevant segment, where moving the relevant segment to a modified alignment results in the three snappable segments possibly being aligned at a non-horizontal, non-vertical angle and spaced equidistantly according to various alignment configurations. In additional embodiments, although the description herein indicates that the equidistant angular alignment system 102 determines snappable segments for aligning with non-horizontal, non-vertical angles, the equidistant angular alignment system 102 is also able to determine snappable segments for aligning with horizontal or vertical angles with similar operations.

As illustrated in FIG. 5A, the equidistant angular alignment system 102 determines a signed distance range for probable segments. To determine this range, the equidistant angular alignment system 102 determines the slope of the relevant segment and extends a ray 502 along that slope. As further illustrated, the equidistant angular alignment system 102, in one or more embodiments, determines an upper angle ray 506, which has a slope equal to that the relevant segment plus a predetermined tolerance angle, extended through the relevant segment midpoint 504. The equidistant angular alignment system 102, in some cases, determines an upper ray 508, having the slope of the relevant segment, extending through the point where upper angle ray 506 intersects the y-axis. In various embodiments, the equidistant angular alignment system 102 determines the perpendicular distance (signed distance) from the origin to the upper ray 508, establishing the signed distance upper bound 510.

As shown, in some cases, the equidistant angular alignment system 102 determines the signed distance lower bound 512 as shown by generating a lower angle ray 514 through the relevant segment midpoint 504 at an angle equal to the slope of the relevant segment minus the predetermined tolerance angle. The equidistant angular alignment system 102 determines the lower ray 516 by determining where the lower angle ray 514 intersects the y-axis. In some embodiments, the equidistant angular alignment system 102 determines a signed distance lower bound 510 by determining the perpendicular distance from the origin to the lower ray 516.

In some embodiments, the equidistant angular alignment system 102 determines which snappable segments fall within the signed distance lower bound 510 and the signed distance upper bound 512. In various cases, the equidistant angular alignment system 102 evaluates the snappable segments within the alignment bin that includes the relevant segment (e.g., the relevant bin) to determine if those snappable segments fall within the signed distance bounds. Additionally, the equidistant angular alignment system 102 also evaluates the snappable segments in the alignment bins directly above and/or below the relevant bin. For example, if the relevant segment is in the bin representing snappable segments that are oriented at a 5-10 degree angle (relative to a horizontal reference line), the equidistant angular alignment system 102 determines whether all other snappable segments in that 5-10 degree alignment bin have signed distances within the signed distance bounds. In various embodiments, the equidistant angular alignment system 102 also determines whether the snappable segments in the neighboring bins (e.g., the 0-5 degree bin and the 10-15 degree bin) have signed distances that fall within the signed distance bounds.

In one or more embodiments, the equidistant angular alignment system 102 uses the snappable segments within the signed distance bounds (tolerance zone) to generate probable alignment triplets. As illustrated in FIG. 5B, the equidistant angular alignment system 102 determines snappable segments within the tolerance zone to be either left aligns or right aligns for one of three possible configurations of alignment. For example, the equidistant angular alignment system 102 determines snappable segments that possibly form a middle equal spacing configuration in which the modified object is between two objects, a left equal spacing configuration in which the modified object is to the right of two objects (relative to the x-axis), or a right equal spacing configuration in which the modified object is to the left of two objects (relative to the x-axis).

In some embodiments, segments that have a maximum x-axis value (xMax) less than the relevant segment minimum x-axis value (xMin) are determined to be left aligns. For example, xMax refers to the maximum value of the x-coordinate of a snappable segment in relation to an x-axis in a coordinate axis system. Relatedly, for example, xMin refers to the minimum value of the x-coordinate of a snappable segment in relation to an x-axis in a coordinate axis system where the x-axis is a horizontal reference line. In various cases, equidistant angular alignment system 102 further sorts left aligns based on their xMax, from greatest to least xMax values (or from least to greatest xMax values), in part to facilitate computational efficiency. Likewise, in one or more embodiments, the equidistant angular alignment system 102 determines that snappable segments having xMin greater than the xMax of the relevant segment are right aligns. Similarly, the equidistant angular alignment system 102 sorts these right aligns according to their xMin (least to greatest or greatest to least). In various embodiments, the equidistant angular alignment system 102 uses this data to determine probable alignment triplets, as further discussed below.

As mentioned above, in certain described embodiments, the equidistant angular alignment system 102 utilizes signed distance bounds, in combination with the positions of snappable segments relative to the relevant segment, to generate an angular alignment guide. In addition, in some embodiments, the equidistant angular alignment system 102 utilizes right aligns and left aligns to determine probable triplets (e.g., probable alignment triplets) for various possible alignment configurations. FIGS. 6A-6B illustrate block diagrams of the equidistant angular alignment system using probable triplets to provide an angular alignment guide for modifying a position of an object in accordance with one or more embodiments.

As illustrated in FIG. 6A, the equidistant angular alignment system 102 performs an act 602 of identifying snappable segments of objects within the viewport of a digital illustration document. As further illustrated, the equidistant angular alignment system 102 utilizes the snappable segments identified in act 602 to perform an act 604 of determining an optimal triplet. Specifically, in some cases, the equidistant angular alignment system 102 performs the act 604 of determining an optimal triplet by performing an act 608 of generating a probable triplet list. In various embodiments, the equidistant angular alignment system 102 further performs act 604 of determining an optimal triplet by alternatively, or additionally, performing act 610 of determining triplet conditions, as further discussed below.

As discussed previously, in certain embodiments, the equidistant angular alignment system 102, performs an act 608 of generating a probable triplet list. In some cases, the probable triplet list includes snappable segments that fall within the tolerance zone, further sorted into left aligns and right aligns. Additionally, the equidistant angular alignment system 102 filters out snappable segments within the tolerance zone, in various cases, by determining which snappable segments within the tolerance zone satisfy (or best satisfy) an equispacing constraint. In various cases, the equidistant angular alignment system 102 utilizes algorithms in tandem to perform act 608 of generating a probable triplet list the algorithms represented by the following pseudo codes:

```
Algorithm 2: Best Probable Angular Alignment Triplets Detection
    Procedure GetProbable AngularAlignmentsCombos(S, E)
Require: S(1 . . . n): input segments of object in translation, E: Environmental snappable
locations maintained in Data structure
    for each line segment L in ListS do
    A = Angle of the segment L
    Tol = Angular tolerance of the Bins
    Find the best segment pair based on following conditions taken in order (i) Angle
A, (ii) Angle (A − Tol), (iii) Angle (A + Tol)
    for each of these angular bins do
    Avg = Average angle of Bin
    LowerRay = Ray passing through segment S and at the angle(Avg − Tol)
    Calculate lower Signed Distance of this Ray from Origin
    LowerDist = SignedDistance of LowerRay from Origin
    UpperRay = Ray passing through segment S and at the angle(Avg + Tol)
    Calculate upper Signed Distance of this Ray from Origin
    UpperDist = Signed Distance of UpperRay from Origin
    Since the list of Parallel lines is sorted based on Signed distance from Origin, using binary
search,
    L = find the lower bound line using the LowerDist as the key for Binary search
    U = find the upper bound line using the UpperDist as the key for Binary search
    All the lines within this range of L and U as the probable angular alignments for the
Segment S
    for each line m within the range L and U as probable alignment do
    Direction = Determine the direction of this snappable segment ‘m’ as either left
aligned or right aligned
    Maintain a list of leftAligns and rightAligns
    Sort the leftAligns based on xMax on snappable segment from max to min
    Sort the rightAligns based on xMin of snappable segment from min to max
    Probable aligns list = Check for angular equi-spacing constraint:
CHECKANGULAREQUISPACINGCONSTRAINT
```

```
Algorithm 3: Check Angular Equispacing Constraint
procedure CHECKANGULAREQUISPACINGCONSTRAINT(S, E)
  there can be 3 cases of alignments
  MIDDLE EQUAL SPACING
  for until not found any match: do
    Li = Take one Segments in leftAlign
    Refdist = L.Xmin − Li.Xmax
    Find the segment in RightAlign Ri whose distance to L is RefDist within tol ir.,
Ri.Xmin − L.Xmax refDist
  If found add to the create a pair of 3 and add to the probable aligns
  ADJACENT EQUAL SPACING LEFT
  for each Li in LeftAlign do
    RefDist = L.Xmin − Li.Xmax
    Search: Find the segments in LeftAlign whose Xmax is: Li.Xmin + (2*RefDist) −
  Li.size within tolerance distance
  If found, add to the create a pair of 3 and add to the probable aligns
  ADJACENT EQUAL SPACING RIGHT
  for each Li in rightAlign do
    RefDist = Li.Xmin − L.Xmax
    Search: Find the segments in rightAlign whose Xmin is: Li.Xmin + (2*RefDist) +
  Li.size within tolerance distance
  If found, add to the create a pair of 3 and add to the probable aligns
```

In some cases, the equidistant angular alignment system 102 performs act 608 generating probable triplet list by multiple methods including by determining alignment configurations based on whether the snappable segments are positioned according to middle triplets or adjacent triplets (left adjacent or right adjacent). For example, a middle triplet refers to a triplet of snappable segments where the relevant segment is positioned in between a first segment and a second segment. By way of illustration, an adjacent triplet is a triplet of snappable segments where the relevant segment is angularly positioned to either the left or right of a first segment and a second segment, where the distance from the relevant segment to the first segment is equal to the distance from the first segment to the second segment along an angular alignment path.

As discussed previously, in one or more embodiments, the equidistant angular alignment system 102 generates a possible middle triplet for the probable triplet list by determining which snappable segments within the tolerance zone satisfy an equispacing constraint. In particular, in some cases, the equidistant angular alignment system 102 determines whether it is possible for the relevant segment to be positioned (within a tolerance distance) in between a first segment and a second segment that fall within the tolerance zone of an alignment path.

Specifically, in one or more embodiments, the equidistant angular alignment system 102 determines a first reference distance from the xMin (minimum x-coordinate value) of the relevant segment to the xMax (maximum x-coordinate value) of a first snappable segment in the list of left aligns. The equidistant angular alignment system 102 also compares the first reference distance against a second reference distance between the xMax of the relevant segment to the xMin of the first snappable segment in the list of right aligns. If the first reference distance is equal to the second reference distance (within a predetermined tolerance), the equidistant angular alignment system 102 adds the first snappable segment of the list of left aligns, the first snappable segment from the list of right aligns, and the relevant segment to the probable triplet list as a possible middle triplet. In one or more embodiments, the equidistant angular alignment system 102 redetermines the second reference distance for each snappable segment in the list of right aligns. In one or more additional embodiments, the equidistant angular alignment system 102 redetermines the first reference distance by using the second segment in the list of left aligns until each segment has been evaluated. In various cases, the equidistant angular alignment system 102 repeats this process until each snappable segment in the left aligns has been evaluated against each snappable segment in the left aligns.

In various embodiments, the equidistant angular alignment system 102 determines possible adjacent triplets for the probable triplet list. In particular, in some cases, the equidistant angular alignment system 102 determines possible left adjacent triplets by determining a reference distance between the xMin of the relevant segment and the xMax of the first left align (first snappable segment within the list of left aligns). In one or more embodiments, the equidistant angular alignment system 102 identifies segments within the left-aligned group (if any) where the xMax value equals the value of the xMin of the first left-aligned segment plus twice the reference distance and minus the x-axis length of the first left-aligned segment. In response to determining an additional left align (snappable segment within the list of left aligns), the equidistant angular alignment system 102 adds the first left align, the relevant segment, and the determined left align as a left triplet to the probable triplet list. In some cases, the equidistant angular alignment system 102 repeats this process for each segment in the list of left aligns.

Similarly, in one or more embodiments, the equidistant angular alignment system 102 determines possible right triplets for the probable triplet list. Specifically, in various cases, the equidistant angular alignment system 102 determines a reference distance representing the difference between xMin of the first right align and xMax of the relevant segment. The equidistant angular alignment system 102, in some cases, determines whether any of the segments within the list of right aligns has an xMin equal to the value of the xMin of the first right align plus twice the reference distance and plus the x-axis length of the first right align. In response to determining an additional right align, the equidistant angular alignment system 102 adds the first right align, the relevant segment, and the determined right align as a right triplet to the probable triplet list. In some cases, the equidistant angular alignment system 102 repeats this process for each segment in the list of right aligns.

In some cases, the equidistant angular alignment system 102 determines probable triplets by utilizing an angular equispacing algorithm. In some cases, the equispacing algorithm is run in tandem with Algorithm 2 (Best Probable Angular Alignment Triplets Detection), with the equispacing algorithm represented by the following pseudo code:

```
Algorithm 3: Check Angular Equispacing Constraint
procedure CHECKANGULAREQUISPACINGCONSTRAINT(S, E)
  there can be 3 cases of alignments
  MIDDLE EQUAL SPACING
  for until not found any match: do
    Li = Take one Segments in leftAlign
    Refdist = L.Xmin − Li.Xmax
    Find the segment in RightAlign Ri whose distance to L is REfDist within tol ir.,
Ri.Xmin − L.Xmax refDist
  If found add to the create a pair of 3 and add to the probable aligns
  ADJACENT EQUAL SPACING LEFT
  for each Li in LeftAlign do
    RefDist = Li.Xmin − L.Xmax
    Search: Find the segments in LeftAlign whose Xmax is: Li.Xmin + (2*RefDist) −
  Li.size within tolerance distance
  If found, add to the create a pair of 3 and add to the probable aligns
  ADJACENT EQUAL SPACING RIGHT
  for each Li in rightAlign do
    RefDist = Li.Xmin − L.Xmax
    Search: Find the segments in rightAlign whose Xmin is: Li.Xmin + (2*RefDist) +
  Li.size within tolerance distance
  If found, add to the create a pair of 3 and add to the probable aligns
```

As illustrated, the equidistant angular alignment system 102 performs act 610 of determining triplet conditions to guide the act 608 of determining an optimal triplet from the list of probable triplets, which is further discussed below in relation to FIG. 6B. In some embodiments, the equidistant angular alignment system 102 further performs act 612 of generating a modified alignment suggestion for the modified object. For example, the equidistant angular alignment system 102 generates a positioning for the modified object where one (or more) of the extracted snappable segments of the modified object is in line with an angular alignment guide according to the optimal triplet. In some embodiments, the equidistant angular alignment system 102 performs act 614 of providing a visible angular alignment guide within the viewport. In some cases, providing a visible angular alignment guide aids a user in knowing where the equidistant angular alignment system 102 recommends positioning the modified object so as to be in equidistant angular alignment with multiple other objects within the viewport.

As further illustrated in FIG. 6A, in some cases the equidistant angular alignment system 102 performs act 616 of moving the relevant segment (and the associated modified object) to a modified alignment position. In some cases, the modified alignment position is along the angular alignment guide such that the modified object is equidistantly spaced at an angle (e.g., not horizontal or vertical) from two or more other objects within the viewport. In some embodiments, at least one segment of the two or more other objects also align with the angular alignment guide. FIG. 6B further illustrates the process of determining an optimal triplet according to one or more embodiments.

As illustrated in FIG. 6B, in various cases, the equidistant angular alignment system 102 determines an optimal triplet from the probable triplet list by evaluating the probable triplet list against one or triplet conditions 632. The conditions include one or more of collinearity 634 with the relevant segment, minimum deflection 636 between the segment of the pair, equal spacing 638, and minimum distance 640 between segments. In some cases, the equidistant angular alignment system 102 evaluates the probable triplets against the triplet conditions 632 in a ranked order. More specifically, in one or more embodiments, the equidistant angular alignment system 102 filters out probable triplets according to triplet conditions 632 in a particular order. For example, the equidistant angular alignment system 102 filters the probable triplet list first by applying conditions of collinearity 634, followed by minimum deflection 636, equal spacing 638, and minimum distance 640.

In some cases, the condition of collinearity 634 refers to detecting whether the probable triplet falls within the signed distance bounds, which the equidistant angular alignment system 102 determines from the perpendicular distance from the origin to a segment or a ray extending from the segment in the direction of the slope of the segment, as discussed in more detail previously. In some cases, the equidistant angular alignment system 102 determines the condition of collinearity by running an algorithm represented by the following pseudo code:

```
Algorithm 4: Almost Collinear Detection
Require: location/segment to compare, ε snapping tolerance
procedure COLLINEAR(l₁, l₂, ε) [symbol] This will check if location l₁ is almost collinear with l₂
  θ₁←angle of l₁
  θ₂←angle of l₂
  θ₁₂←angle of line formed by joining end point of l₁ and start of l₂
  error←max (|θ₁-θ₂|, |θ₁-θ₁₂|, |θ₂-θ₁₂|)
  if error < ε then
    return error, true
  return error, false
```

Additionally, in some embodiments, the equidistant angular alignment system 102 applies a condition of minimum deflection 636, which determines a difference in slope between the relevant segment and the other snappable segments in the probable triplet (two or more segments extracted from two or more other objects). Specifically, the filter of minimum deflection 636 removes probable triplets where the slope of the probable triplet pairs (the slope of the two or more segments that are not the relevant segment) are not within a predetermined tolerance of the slope of the relevant segment.

In various embodiments, as mentioned, the equidistant angular alignment system 102 also applies the condition of equal spacing 638 to the list of probable triplets. In some cases, the equidistant angular alignment system 102 utilizes the condition of equal spacing 638 to determine segment pairs from the list of probable triplets that have the most equal spacing. Additionally, in one or more embodiments, if there are multiple probable triplets with equal spacing, the equidistant angular alignment system 102 will determine the probable triplet with the minimum distance to between snappable segments to be the optimal triplet. For example, the equidistant angular alignment system determines the distance between the relevant segment and the other segments in the probable triplet along an angular path. Additionally, in various cases, the equidistant angular alignment system 102 applies a condition of minimum distance 640 to determine which of the probable triplets has the shortest distance between each of the segments in the triplet along an angular path. In some cases, the equidistant angular alignment system 102 determines that the probable triplet that best meets the triplet conditions 632 is the optimal triplet. In one or more embodiments, the equidistant angular alignment system 102 utilizes the optimal triplet as the basis of determining a modified alignment position for the modified object.

In some cases, the equidistant angular alignment system 102 determines an optimal triplet by applying an algorithm represented by the following pseudo code:

```
Algorithm 5: Best Angular Alignment Triplet Detection
  procedure GETBESTANGULARALIGNMENTTRIOS(S, E)
Require: S(1 . . . n): input segments of object in translation, E: Environmental snappable
locations maintained in Data structure
L Get Probable Angular Alignment Lines from Env With input segments (S1 . . . n)-
GETPROBABLEALIGNMENTCOMBOS(s, E)
  for each probable alignment triplet in list L do
  Find the best segment pair based on the following conditions taken in order:
    Condition for collinearity with Segment
    Condition of minimum deflection between the segment of the pair
    Condition of equispacing distance. The segment pair at minimal distance from each
other are given priority
```

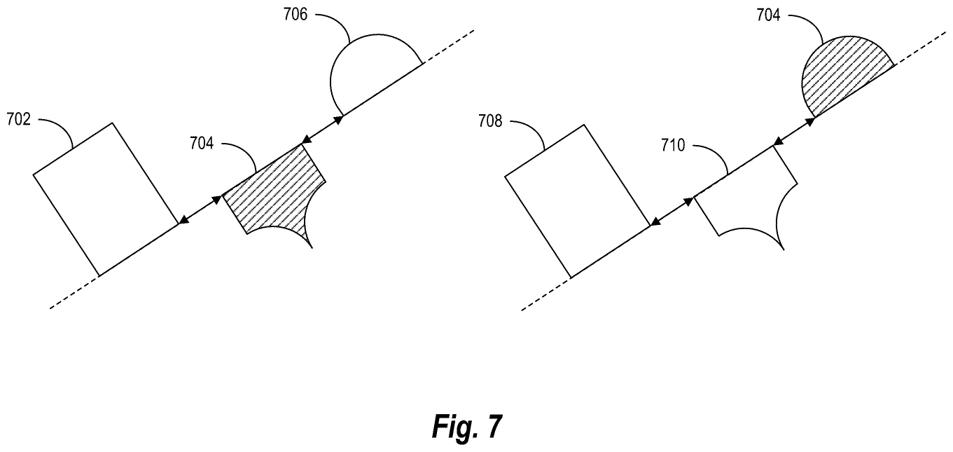

FIG. 7 illustrates an example of using an equidistant angular alignment system to generate suggested equidistant angular alignments in accordance with one or more embodiments. In particular, as illustrated in FIG. 7, the equidistant angular alignment system 102 places the modified object 704 in a modified alignment position corresponding to the optimal triplet, as discussed previously. In some embodiments, the equidistant angular alignment system 102 places the modified object 704 in a modified alignment position such that the modified object is in between two existing art objects (e.g., objects 702, 706) along an angular alignment guide. In such cases, the equidistant angular alignment system 102 determines the optimal triplet to be a middle triplet.

In other embodiments, the equidistant angular alignment system 102 places the modified object 704 to the right of two or more existing art objects (e.g., objects 708, 710), positioned such that the three or more objects are equal distances apart along an angular alignment guide. In such cases, the equidistant angular alignment system 102 determines the optimal triplet to be a left adjacent triplet. Further, in some embodiments, the equidistant angular alignment system 102 places the modified object 704 to the left of two or more existing art objects (relative to an x-axis), positioned such that the three or more objects are equal distances apart on an angular alignment guide. In such cases, the equidistant angular alignment system 102 determines the optimal triplet to be a right adjacent triplet.

In some cases, the equidistant angular alignment system 102 positions the modified object according to algorithms described by the following pseudo codes:

```
Algorithm 6: Angular Alignment Triplet Snapping
procedure SNAPPING(S, E)
  Angle = Determine the average angle of the segments 2 stationary objects of triplets. This
is the reference angle for object in translation.
  Reference collinear line = Determine the middle location of the perpendicular height line
between the segments 2 stationary objects of triplets. This is the collinear line for object in
translation.
  ANGLE PERPENDICULAR TRANSLATION
  D = Determine the perpendicular distance between the reference stationary colinear line
and the segment in translation.
  Translate the object (in translation) perpendicularly to come in collinear line by the distance
D
  EQUISPACED TRANSLATION
  if triplet corresponds to Middle Equal spacing: then
    Determine the midpoint of Left.Xmax and Right.Xmin
    Translate the object to align the concerned segment center with the center
  calculated above
  if triplet corresponds to Adjacent Left then
    Determine the space between L1.Xmax and L2.Xmin
    Translate the object to align the segment Xmax with (L1.Xmin − space)
  if triplet corresponds to Right then
    Determine the space between L1.Xmax and L2.Xmin
    Translate the object to align the segment Xmin with (L1.Xmax + space)
```

```
Algorithm 7: Object Translation Equi-Distant Snapping
Require: S(1 . . . n): input segments of object in translation, E: Environmental snappable
locations maintained in Data structure
  W Get the best angular alignment trio for each input segments in s in S(1 . . . n):
  GETBESTANGULAR- ALIGNMENTTRIO(s, E)
  Do snapping
  Do hinting
```

In one or more embodiments, the equidistant angular alignment system 102 positions (snaps) the relevant segment (and modified object) according to the best angular alignment triplet (e.g., optimal triplet) as determined by processes described above. In moving the relevant segment, in some cases, the equidistant angular alignment system 102 determines a reference collinear line. For example, a reference collinear line refers to a line in the perpendicular middle location of the two non-modified segments (segments that are not relevant segments) of the optimal triplet. In various embodiments, the equidistant angular alignment system 102 translates (positions/snaps) the relevant segment perpendicularly to align the relevant segment with the collinear line.

In some embodiments, the equidistant angular alignment system 102 positions the relevant segment according to multiple processes depending on whether the optimal triplet is a middle triplet, left triplet, or right triplet. In various cases, the equidistant angular alignment system 102 aligns a relevant segment of a middle triplet according to the midpoint of the optimal triplet. For example, the midpoint of the optimal triplet refers to the midpoint of the leftmost x-value and the rightmost x-value of the three segments of the middle triplet. In some cases, the equidistant angular alignment system 102 positions the midpoint of the relevant segment with the midpoint of the optimal triplet when the optimal triplet is a middle triplet.

In various embodiments, the equidistant angular alignment system 102 positions the relevant segment of a left triplet by determining the distance between the two non-modified segments. In some cases, the equidistant angular alignment system 102 positions the relevant segment such that the relevant segment xMax is the aligned with an x-value equal to the leftmost non-modified segment xMin minus the distance between the two non-modified segments. Relatedly, in some embodiments, the equidistant angular alignment system 102 positions the relevant segment of a right triplet such that the relevant segment xMin is aligned with an x-value equal to the rightmost non-modified segment xMax plus the distance between the two non-modified segments.

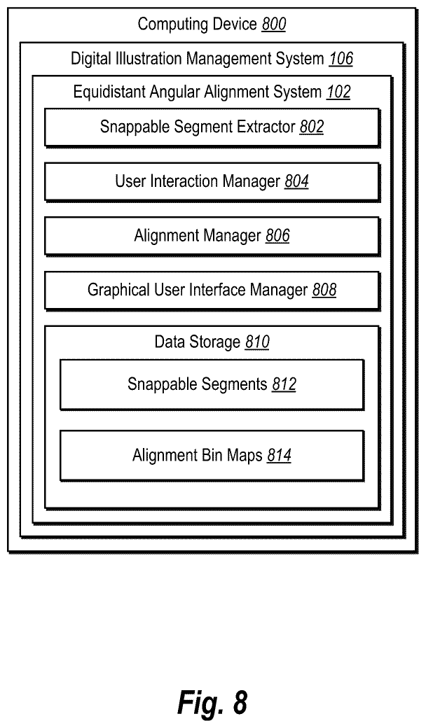

Looking now to FIG. 8, additional detail will be provided regarding components and capabilities of the equidistant angular alignment system 102. Specifically, FIG. 8 illustrates an example schematic diagram of the equidistant angular alignment system 102 on an example computing device 800 (e.g., one or more of the client device 110 and/or the server device(s) 104). In some embodiments, the computing device 800 refers to a distributed computing system where different managers are located on different devices, as described above. As shown in FIG. 8, the equidistant angular alignment system 102 includes a snappable segment extractor 802, a user interaction manager 804, an alignment manager 806, a graphical user interface manager 808, and a data storage 810 comprising snappable segments 812 and alignment bin maps 814.

As just mentioned, the equidistant angular alignment system 102 includes a snappable segment extractor 802. In particular, the snappable segment extractor 802 detects a snappable segment associated with an object within the viewport of a digital illustration document and identifies snappable lines segments of an object according to Bezier (or other) segments associated with the object (linear lines, almost linear lines, curved lines, tangents). For example, the snappable segment extractor 802 performs an anchor point analysis on Bezier curves of the one or more objects within a viewport of a digital illustration document. Additionally, in some cases, the snappable segment extractor 802 generates snappable segments based on the one or more objects segmented according to anchor points of Bezier curves (identifying linear line segments, almost linear line segments, curved line segments, and tangents). The snappable segment extractor 802 thus extracts snappable segments from one or more objects in a viewport of a digital illustration document relative to the associated Bezier curves of the edge of one or more objects.

As shown, the equidistant angular alignment system 102 also includes a user interaction manager 804. In particular, the user interaction manager 804 manages, maintains, detects, determines, or identifies user interactions with one or more objects within a viewport of a digital illustration document. For example, the user interaction manager 804 detects or determines one or more user interactions (a scaling action, a rotation action, a translation action, some combination thereof, etc.) with one or more objects visible within a viewport of a digital illustration document.

As further illustrated in FIG. 8, the equidistant angular alignment system 102 includes an alignment manager 806. In particular, the alignment manager 806 manages, maintains, determines, identifies, or generates a modified alignment for a modified object based on the position of two or more extracted snappable segments of two or more additional objects and a relevant segment of the modified object. For example, the alignment manager 806 generates an angular alignment guide based on the position of the modified object and two or more objects within the digital illustration document. In some cases, the alignment manager 806 further determines a modified alignment for the modified object such that the relevant segment of the modified object is along the angular alignment guide.

Additionally, the equidistant angular alignment system 102 includes a graphical user interface manager 808. In particular, the graphical user interface manager 808 manages, maintains, extrapolates, determines, detects, or generates a visible angular alignment guide for display within a viewport displaying a digital illustration document. For example, the graphical user interface manager 808 generates a visible angular alignment guide along with a snapping function for moving the modified object into a modified alignment position. Indeed, the graphical user interface manager 808 provides a snapping function that moves the modified object into the modified alignment position when the modified object is moved within a predetermined distance of the modified alignment position. Corresponding to the position of one or more objects in the viewport, the graphical user interface manager 808 snaps the modified object to the modified alignment such that the modified object and two or more other objects are angularly aligned at equal distances.

As further illustrated in FIG. 8, the equidistant angular alignment system 102 includes data storage 810. The data storage 810 operates in conjunction with, or includes, the snappable segment extractor 802, the user interaction manager 804, the alignment manager 806, and/or the graphical user interface manager 808. As shown in FIG. 8, the data storage 810 includes snappable segments 812, accessible and usable by other components of the equidistant angular alignment system 102. In some cases, the data storage 810 also stores alignment bin maps 814 accessible and usable by other components of the equidistant angular alignment system 102. In some cases, the data storage 810 communicates with the other components of the equidistant angular alignment system 102 to facilitate the operations and functions described herein.

In one or more embodiments, each of the components of the equidistant angular alignment system 102 are in communication with one another using any suitable communication technologies. Additionally, the components of the equidistant angular alignment system 102 is in communication with one or more other devices including one or more client devices described above. It will be recognized that although the components of the equidistant angular alignment system 102 are shown to be separate in FIG. 8, any of the subcomponents may be combined into fewer components, such as into a single component, or divided into more components as may serve a particular implementation. Furthermore, although the components of FIG. 8 are described in connection with the equidistant angular alignment system 102, at least some of the components for performing operations in conjunction with the equidistant angular alignment system 102 described herein may be implemented on other devices within the environment.

The components of the equidistant angular alignment system 102, in one or more implementations, includes software, hardware, or both. For example, the components of the equidistant angular alignment system 102 include one or more instructions stored on a computer-readable storage medium and executable by processors of one or more computing devices (e.g., the computing device 800). When executed by the one or more processors, the computer-executable instructions of the equidistant angular alignment system 102 cause the computing device 800 to perform the methods described herein. Alternatively, the components of the equidistant angular alignment system 102 comprises hardware, such as a special purpose processing device to perform a certain function or group of functions. Additionally, or alternatively, the components of the equidistant angular alignment system 102 includes a combination of computer-executable instructions and hardware.

Furthermore, the components of the equidistant angular alignment system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the equidistant angular alignment system 102 may be implemented as part of a stand-alone application on a personal computing device or a mobile device. Alternatively, or additionally, the components of the equidistant angular alignment system 102 may be implemented in any application that allows creation and delivery of marketing content to users, including, but not limited to, applications in ADOBE® CREATIVE CLOUD®, such as ADOBE® PHOTOSHOP®, ILLUSTRATOR®, and INDESIGN®. “ADOBE,” “CREATIVE CLOUD,” “PHOTOSHOP,” “ILLUSTRATOR,” and “INDESIGN” are either registered trademarks or trademarks of Adobe Inc. in the United States and/or other countries.

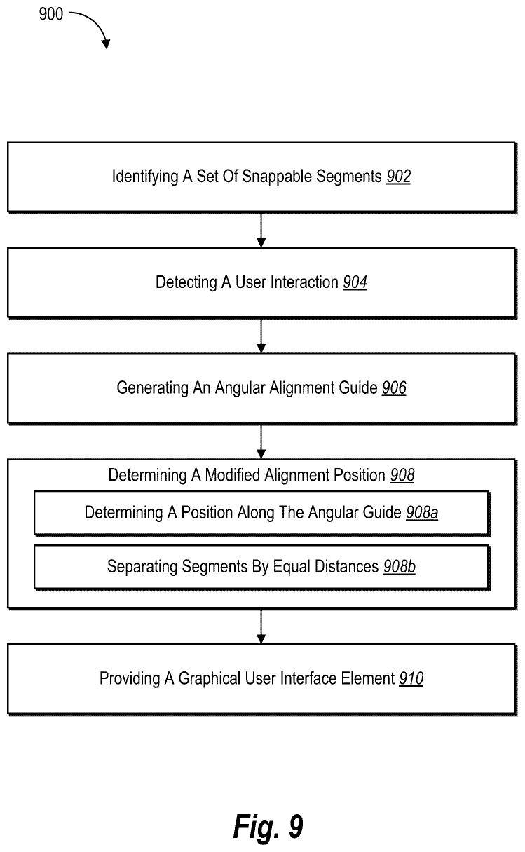

FIGS. 1-8, the corresponding text, and the examples provide a number of different systems, methods, and non-transitory computer readable media for generating an equidistant angular alignment for a modified object. In addition to the foregoing, embodiments are describable in terms of flowcharts comprising acts for accomplishing a particular result. For example, FIG. 9 illustrates flowcharts of example sequences or series of acts in accordance with one or more embodiments.

While FIG. 9 illustrate acts according to particular embodiments, alternative embodiments may omit, add to, recorder, and/or modify any of the acts shown in FIG. 9. The acts of FIG. 9 are sometimes performed as part of a method. Alternatively, a non-transitory computer readable medium comprises instructions that, when executed by one or more processors, cause a computing device to perform the acts of FIG. 9. In still further embodiments, a system performs the acts of FIG. 9. Additionally, the acts described herein may be repeated or performed in parallel with one another or in parallel with different instances of the same or other similar acts.

FIG. 9 illustrates a flowchart of a series of acts 900 for modifying an object using a modified alignment in accordance with one or more embodiments. In particular, the series of acts 900 includes an act 902 of identifying snappable segments within a digital illustration document. For example, the act 902 involves identifying a set of snappable segments within a graphical user interface of a digital illustration application, the set of snappable segments comprising a first segment associated with a first object, a second segment associated with a second object, and a third segment associated with a third object. In addition, the series of acts 900 includes an act 904 of detecting a user interaction for modifying the first object.

As further illustrated in FIG. 9, the series of acts 900 includes an act 906 generating an angular alignment guide. In particular, the act 906 involves generating, based on the user interaction and the set of snappable segments, an angular alignment guide that extends along an non-vertical and non-horizontal angle that is in line with the second segment and the third segment.

As shown in FIG. 9, the series of acts 900 includes an act 908 of determining a modified alignment position. For example, the act 908 includes determining, based on the user interaction and the angular alignment guide, a modified alignment position for the first object that positions the first object along the angular alignment guide such that the first segment, second segment, and third segment are separated by equal distances along the angular alignment guide. In particular, the act 908 includes an act 908a of determining a position along the angular guide. Additionally, the act 908 includes an act 908b of separating segments by equal distances.

Additionally, the series of acts 900 includes an act 910 of providing a graphical user interface element. For example, the act 910 involves providing a snappable graphical user interface element in the graphical user interface that, upon selection, causes the first object to move into the modified alignment position.

In one or more embodiments the series of acts 900 includes an act of identifying a set of snappable segments by determining linear segments, near linear segments, and tangential segments from a plurality of objects.

In some cases, the series of acts 900 includes an act of generating an angular alignment guide by assigning the set of snappable segments into angular alignment bins based on slopes of the snappable segments. In addition, the series of acts 900 includes, based on a slope of the first segment, identifying one or more corresponding angular alignment bins. Further, the series of acts 900 includes an act of determining the angular alignment guide by identifying an angular line along which at least two segments in the one or more corresponding angular alignment bins are positioned and has a minimum alignment difference from the first segment. In some cases, the series of acts 900 includes acts of determining a signed distance from an origin of the graphical user interface for each of the snappable elements. Furthermore, the series of acts 900 includes an act of sorting the snappable elements in each angular alignment bin based on the signed distance values. Additionally, the series of acts 900 includes an act of identifying the angular line along which at least two segments in the one or more corresponding angular alignment bins are positioned and has a minimum alignment difference from the first segment based on the signed distances of the snappable elements in the one or more corresponding angular alignment bins.

In certain embodiments, the series of acts 900 includes an act of providing a snappable graphical user interface element by determining a second angle based on an angle of the second segment relative to a horizontal reference line and a third angle based on an angle of the third segment relative to the horizontal reference line. In addition, the series of acts 900 includes an act of determining a reference angle based on the second angle and the third angle. Further, the series of acts 900 includes an act of providing a snappable graphical user interface element in the graphical user interface that, upon selection, causes the first object to move into the modified alignment position such that the first object is oriented at the reference angle.

In one or more embodiments, the series of acts 900 includes an act of determining a modified alignment position for the first object by determining a second position of the second segment and a third position of the third segment. Additionally, the series of acts 900 includes an act of determining a reference collinear line positioned in between the second position and the third position. Further, the series of acts 900 includes an act of determining a modified alignment position for the first object that positions the first object based on the reference collinear line.

In some embodiments, the series of acts 900 includes identifying a set of snappable segments of objects within a graphical user interface of a digital illustration application; detecting one or more user interactions modifying a first object; determining, based on the one or more user interactions and the set of snappable segments, a modified alignment position for the first object that positions the first object at a non-vertical and non-horizontal angle between a second object and a third object such that the first object is equally spaced from the second object and the third object; and providing a snappable graphical user interface element in the graphical user interface that, upon selection, causes the first object to move into the modified alignment position.

In some cases, the series of acts 900 includes an act of determining the modified alignment position by determining a first segment associated with the first object, a second segment associated with the second object, and a third segment associated with the third object. Further, the series of acts 900 involves determining a modified alignment such that the first segment is equally spaced from the second segment and the third segment.

In various cases, the series of acts 900 includes an act of determining the modified alignment position by determining a subset of the set of snappable segments based on a maximum angle and a minimum angle based on a slope of the first object relative to a horizontal reference line. Additionally, in some cases, the series of acts 900 includes determining an optimal alignment triplet from the subset of the set of snappable segments. Further, the series of acts 900 includes an act of determining a modified alignment position for the first object based on the optimal alignment triplet.

In some embodiments, the series of acts 900 includes an act of determining the modified alignment position by determining an optimal alignment triplet from the subset of the set of snappable segments based on one or more of: a predetermined collinearity condition, a predetermined deflection tolerance, or a spacing between a first segment of the subset of the set of snappable segments and a second segment of the subset of the set of snappable segments. In these or other embodiments, the series of acts 900 includes an act of determining a modified alignment position for the first object based on the optimal alignment triplet.

In one or more embodiments, the series of acts 900 includes an act of determining the modified alignment position by generating a left alignment bin that contains one or more objects disposed to a left side of the first object relative to a coordinate axis and a right alignment bin that contains one or more objects disposed to a right side of the first object relative to the coordinate axis. Further, the series of acts 900 includes an act of determining that the second object is located in the left alignment bin and the third object is located in the right alignment bin. Additionally, the series of acts 900 includes an act of determining a modified alignment position for the first object based on the left alignment bin and the right alignment bin. In certain embodiments, the series of acts 900 includes acts of determining the modified alignment position by generating a left subset of the set of snappable segments based on positions of the set of snappable segments relative to the first object. In addition, the series of acts 900 includes an act of generating a right subset of the set of snappable segments based on positions of the set of snappable segments relative to the first object. Further, the series of acts 900 involves an act of determining a left segment from the left subset that is positioned a first distance from the first object and a right segment from the right subset that is positioned a second distance from the first object equal to the first distance. In some cases, the series of acts 900 includes an act of determining a modified alignment position for the first object based on the left segment and the right segment.

In certain embodiments, the series of acts 900 includes an act of causing the first object to move into the modified alignment position by generating a reference collinear line in a middle location of a perpendicular height between the second object and the third object. In addition, the series of acts 900 involves an act of generating a midpoint between a right endpoint of the second object and a left endpoint of the third object. Furthermore, the series of acts 900 includes acts of performing translation of the first object based on the reference collinear line and the midpoint such that the first object is equally spaced from the second object and the third object.

In some embodiments, the series of acts 900 includes determining a set of snappable segments associated with a set of objects within a graphical user interface of a digital illustration application; receiving a user interaction to modify a first object; determining, based on the user interaction and the set of snappable segments, a modified alignment position for the first object that positions the first object in non-vertical and non-horizontal angular alignment with a second object and a third object such that a first distance from the first object to the second object is equal to a second distance from the second object to the third object; and providing a snappable graphical user interface element in the graphical user interface that, upon selection, causes the first object to move into the modified alignment position.

In one or more embodiments, the series of acts 900 includes an act of determining the modified alignment position by generating a first subset of the set of snappable segments that comprises a plurality of segments of the set of snappable segments disposed to a left side of the first object relative to a coordinate axis. In addition, the series of acts 900 involves an act of generating a second subset of the set of snappable segments that comprises a plurality of segments of the set of snappable segments disposed to a right side of the first object relative to a coordinate axis. Further, the series of acts 900 includes an act of determining a modified alignment position for the first object based on a first snappable segment located within the first subset and a second snappable segment located within the second subset such that the first snappable segment and second snappable segment are equally spaced relative to the first object.

In some embodiments, the series of acts 900 includes an act of determining a modified alignment position for the first object by determining a first segment of the set of snappable segments associated with the first object having a first slope relative to a horizontal reference line. In addition, the series of acts 900 includes an act of generating a plurality of angular alignment bins comprising a first angular alignment bin that contains a subset of the set of snappable segments having a slope within a predetermined tolerance of the first slope relative to the horizontal reference line. Further, the series of acts 900 includes an act of determining, based on the plurality of angular alignment bins, a modified alignment position for the first object.

In various cases, the series of acts 900 includes an act of determining a modified alignment position for the first object by determining a first segment of the set of snappable segments associated with the first object having a slope relative to a horizontal reference line. In addition, the series of acts 900 includes an act of determining a signed distance tolerance based on a predetermined angle tolerance and the slope of the first object. Further, the series of acts 900 includes acts of generating a subset of the set of snappable segments that fall within the signed distance tolerance. Moreover, the series of acts 900 includes an act of determining a modified alignment position for the first object based on the subset of the set of snappable segments that fall within the signed distance tolerance.

In some embodiments, the series of acts 900 includes an act of determining a modified alignment position for the first object by generating a subset of the set of snappable segments that comprises a plurality of segments of the set of snappable segments disposed to a left side of the first object relative to a coordinate axis. In addition, the series of acts 900 includes an act of determining a modified alignment position for the first object based on a first snappable segment located within the subset and a second snappable segment located within the subset.

In certain cases, the series of acts 900 includes an act of determining a modified alignment position for the first object by generating a subset of the set of snappable segments that comprises a plurality of segments and the set of snappable segments disposed to a right side of the first object relative to a coordinate axis. Further, the series of acts 900 includes an act of determining a modified alignment position for the first object based on a first snappable segment located within the subset and a second snappable segment located within the subset such that the first snappable segment and second snappable segment are equally spaced relative to the first object.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 10 illustrates, in block diagram form, an example computing device 1000 (e.g., the computing device(s) 800, the client device 110, and/or the server device(s) 104) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A computer-implemented method comprising:
identifying a set of snappable segments within a graphical user interface of a digital illustration application, the set of snappable segments comprising a first segment associated with a first object, a second segment associated with a second object, and a third segment associated with a third object;
detecting a user interaction for modifying the first object;
generating, based on the user interaction and the set of snappable segments, an angular alignment guide that extends along a non-vertical and non-horizontal angle that is in line with the second segment and the third segment;
determining, based on the user interaction and the angular alignment guide, a modified alignment position for the first object that positions the first object along the angular alignment guide such that the first segment, second segment, and third segment are separated by equal distances along the angular alignment guide; and
providing a snappable graphical user interface element in the graphical user interface that, upon selection, causes the first object to move into the modified alignment position.

2. The computer-implemented method of claim 1, wherein identifying a set of snappable segments comprises determining linear segments, near linear segments, and tangential segments from a plurality of objects.

3. The computer-implemented method of claim 1, wherein generating an angular alignment guide comprises:
assigning the set of snappable segments into angular alignment bins based on slopes of the snappable segments;
based on a slope of the first segment, identifying one or more corresponding angular alignment bins; and
determining the angular alignment guide by identifying an angular line along which at least two segments in the one or more corresponding angular alignment bins are positioned and has a minimum alignment difference from the first segment.

4. The computer-implemented method of claim 3, further comprising:
determining a signed distance from an origin of the graphical user interface for each of the snappable elements; and
sorting the snappable elements in each angular alignment bin based on the signed distance values.

5. The computer-implemented method of claim 4, further comprising identifying the angular line along which at least two segments in the one or more corresponding angular alignment bins are positioned and has a minimum alignment difference from the first segment based on the signed distances of the snappable elements in the one or more corresponding angular alignment bins.

6. The computer-implemented method of claim 1, wherein providing a snappable graphical user interface element comprises:
determining a second angle based on an angle of the second segment relative to a horizontal reference line and a third angle based on an angle of the third segment relative to the horizontal reference line;
determining a reference angle based on the second angle and the third angle; and
providing a snappable graphical user interface element in the graphical user interface that, upon selection, causes the first object to move into the modified alignment position such that the first object is oriented at the reference angle.

7. The computer-implemented method of claim 1, wherein determining a modified alignment position for the first object comprises:
determining a second position of the second segment and a third position of the third segment;
determining a reference collinear line positioned in between the second position and the third position; and
determining a modified alignment position for the first object that positions the first object based on the reference collinear line.

8. A non-transitory computer-readable medium storing instructions that, when executed by at least one processing device, cause the at least one processing device to perform operations comprising:
identifying a set of snappable segments of objects within a graphical user interface of a digital illustration application;
detecting one or more user interactions modifying a first object;
determining, based on the one or more user interactions and the set of snappable segments, a modified alignment position for the first object that positions the first object at a non-vertical and non-horizontal angle between a second object and a third object such that the first object is equally spaced from the second object and the third object; and
providing a snappable graphical user interface element in the graphical user interface that, upon selection, causes the first object to move into the modified alignment position.

9. The non-transitory computer-readable medium of claim 8, wherein determining the modified alignment position comprises:
determining a first segment associated with the first object, a second segment associated with the second object, and a third segment associated with the third object; and
determining a modified alignment such that the first segment is equally spaced from the second segment and the third segment.

10. The non-transitory computer-readable medium of claim 8, wherein determining the modified alignment position comprises:
determining a subset of the set of snappable segments based on a maximum angle and a minimum angle based on a slope of the first object relative to a horizontal reference line;
determining an optimal alignment triplet from the subset of the set of snappable segments; and
determining a modified alignment position for the first object based on the optimal alignment triplet.

11. The non-transitory computer-readable medium of claim 8, wherein determining the modified alignment position further comprises:
determining an optimal alignment triplet from the subset of the set of snappable segments based on one or more of:
a predetermined collinearity condition;
a predetermined deflection tolerance; or
a spacing between a first segment of the subset of the set of snappable segments and a second segment of the subset of the set of snappable segments; and
determining a modified alignment position for the first object based on the optimal alignment triplet.

12. The non-transitory computer-readable medium of claim 8, wherein determining the modified alignment position comprises:
generating a left alignment bin that contains one or more objects disposed to a left side of the first object relative to a coordinate axis and a right alignment bin that contains one or more objects disposed to a right side of the first object relative to the coordinate axis;
determining that the second object is located in the left alignment bin and the third object is located in the right alignment bin; and
determining a modified alignment position for the first object based on the left alignment bin and the right alignment bin.

13. The non-transitory computer-readable medium of claim 8, wherein determining the modified alignment position comprises:
generating a left subset of the set of snappable segments based on positions of the set of snappable segments relative to the first object;
generating a right subset of the set of snappable segments based on positions of the set of snappable segments relative to the first object;
determining a left segment from the left subset that is positioned a first distance from the first object and a right segment from the right subset that is positioned a second distance from the first object equal to the first distance; and
determining a modified alignment position for the first object based on the left segment and the right segment.

14. The non-transitory computer-readable medium of claim 8, wherein causing the first object to move into the modified alignment position comprises:
generating a reference collinear line in a middle location of a perpendicular height between the second object and the third object;
generating a midpoint between a right endpoint of the second object and a left endpoint of the third object; and
performing translation of the first object based on the reference collinear line and the midpoint such that the first object is equally spaced from the second object and the third object.

15. The non-transitory computer-readable medium of claim 8, wherein determining the modified alignment position comprises:
generating a first subset of the set of snappable segments that comprises a plurality of segments of the set of snappable segments disposed to a left side of the first object relative to a coordinate axis;
generating a second subset of the set of snappable segments that comprises a plurality of segments of the set of snappable segments disposed to a right side of the first object relative to a coordinate axis; and
determining a modified alignment position for the first object based on a first snappable segment located within the first subset and a second snappable segment located within the second subset such that the first snappable segment and second snappable segment are equally spaced relative to the first object.

16. A system comprising:
at least one processor; and
at least one non-transitory computer-readable storage medium storing instructions that, when executed by the at least one processor, cause the system to perform operations comprising:
determining a set of snappable segments associated with a set of objects within a graphical user interface of a digital illustration application;
receiving a user interaction to modify a first object;
determining, based on the user interaction and the set of snappable segments, a modified alignment position for the first object that positions the first object in non-vertical and non-horizontal angular alignment with a second object and a third object such that a first distance from the first object to the second object is equal to a second distance from the second object to the third object; and
providing a snappable graphical user interface element in the graphical user interface that, upon selection, causes the first object to move into the modified alignment position.

17. The system of claim 16, wherein determining a modified alignment position for the first object comprises:
determining a first segment of the set of snappable segments associated with the first object having a first slope relative to a horizontal reference line;
generating a plurality of angular alignment bins comprising a first angular alignment bin that contains a subset of the set of snappable segments having a slope within a predetermined tolerance of the first slope relative to the horizontal reference line; and
determining, based on the plurality of angular alignment bins, a modified alignment position for the first object.

18. The system of claim 16, wherein determining a modified alignment position for the first object comprises:
determining a first segment of the set of snappable segments associated with the first object having a slope relative to a horizontal reference line;
determining a signed distance tolerance based on a predetermined angle tolerance and the slope of the first object;
generating a subset of the set of snappable segments that fall within the signed distance tolerance; and
determining a modified alignment position for the first object based on the subset of the set of snappable segments that fall within the signed distance tolerance.

19. The system of claim 16, wherein determining a modified alignment position for the first object comprises:
generating a subset of the set of snappable segments that comprises a plurality of segments of the set of snappable segments disposed to a left side of the first object relative to a coordinate axis; and
determining a modified alignment position for the first object based on a first snappable segment located within the subset and a second snappable segment located within the subset.

20. The system of claim 16, wherein determining a modified alignment position for the first object comprises:
generating a subset of the set of snappable segments that comprises a plurality of segments of the set of snappable segments disposed to a right side of the first object relative to a coordinate axis; and
determining a modified alignment position for the first object based on a first snappable segment located within the subset and a second snappable segment located within the subset such that the first snappable segment and second snappable segment are equally spaced relative to the first object.
